(19) United States
(12) Patent Application Publication
(10) Pub. No.: US 2004/0148247 A1
(43) Pub. Date: Jul. 29, 2004

(54) Network-based systems, methods, and software for initiating or executing financial transactions

(76) Inventors: Lawrence Miller, New York, NY (US); Tamara Sablic, Brooklyn, NY (US); Silvio Oliviero, London (GB); Lee McGinty, London (GB); Paulo Rodelo, Harrison, NY (US); Brian Pasierb, New York, NY (US)

Correspondence Address: Glen E. Books, Esq., Lowenstein Sandler, 65 Livingston Avenue, Roseland, NJ, 07068, US

(21) Appl. No.: 10/412,886

(22) Filed: Apr. 14, 2003

Related U.S. Application Data
(60) Provisional application No. 60/442,580, filed on Jan. 24, 2003.

(51) Int. Cl. G06F 17/60

(52) U.S. Cl. 705/37; 705/36

(57) ABSTRACT

Network-based systems, software, architecture, and methods, where large amounts of continually updated financial information are dynamically represented as pictorial images on a interface. A user of the interface can initiate and/or execute financial transactions with respect to financial instruments by selecting image locations in connection with the financial instruments, thereby, instructing transactional software to transmit transaction instructions over a network to a network-based trading platform.

### 1. CROSS REFFERENCE TO RELATED APPLICATIONS

This application claims the benefit of U.S. Provisional Application No. 60/442,580 filed on Jan. 24, 2003, which application is hereby incorporated herein by reference in its entirety.

### 2. FIELD

This invention relates to network-based systems, methods, architecture, and software for initiation, execution or both, of financial transactions by way of an interactive interface.

### 3. BACKGROUND

Financial institutions collect and process large amounts of information regarding numerous variables that affect investment prices, including, for example, data from real-time feeds and from risk-management systems. The resulting analytic and historical databases hold an enormous amount of data, analysis of which is crucial to decision making. This analysis is extremely complicated, not only because of the large amount of data, but also because of the dynamic and interdependent relationship between markets. For example, interest rates, currency, stocks, futures, and options all have intertwined relationships. An event that affects the price of one often affects the price of one or more of the others. News, rumors, and political uncertainty affect all markets. Traders and analysts who can make the most sense of the large amount of available information can best realize opportunity and avoid failure.

Large quantities of numerical data are difficult, if not impossible, to understand quickly. To cope with these large quantities of numerical data, the financial industry employs visualization. Using color, size, shape, and animation, visualization tools condense dozens of market data screens, databases and financial reports allowing users to process information more effectively. Visual representations of normal data correlations become familiar to traders and analysts. Visual representations of data abnormalities can indicate opportunities.

A “heatmap” or “color map” is a visual representation of data, wherein color shade (“temperature”) and location is used to display information, which includes numerical values. Heatmaps use color, sound, animation and pattern to organize voluminous and complex data about multiple financial instruments or positions into a live picture. In heatmaps, color indexes run on a continuum from one color through another, e.g., green to red or yellow to blue. The color matrix of all rows and columns in the data set forms the heatmap. A heatmap can even be structured for continuous update by real-time data feeds. As the heatmap receives such information, the color and intensity of the picture changes, which indicates a shift in value. With this picture, opportunities and trends are quickly recognized.

For instance, a plurality of cells, each representing a separate financial instrument, can be organized in separate sectors on a computer screen in a logical grouping. The color of each cell is determined by custom analysis applied to the financial instrument within the cell. As the heatmap receives information from real-time data feeds, the color and intensity of each individual cell changes to indicate a shift in value. An index bar shows the numerical color range of the according to a chosen formula. The color of the cell correlates with the color index bar at the bottom of the heatmap screen. Further, more sophisticated heatmaps provide a chart and detailed information instantly in connection with a particular financial instrument as a computer mouse is rolled over individual cells, for example, instant access to company news, fundamentals, analyst information and more, for any of the stocks.

There are a number of network-based trading systems for real-time security trading currently available to investors. With an automated system, a trader may enter an order to buy or sell, which is transmitted to the central system of the applicable exchange. There, it is matched with another trader who is willing to sell or buy the same securities. The central system of the applicable exchange then confirms the completion of the transaction to each trader.

For example, the company Ore Software (http://www.orcsoftware.com) markets standardized software and provides architecture for pricing and trading derivative securities in real time. Ore has access to many investors and allows subscribers to trade simultaneously on more than thirty-five marketplaces around the world.

While Internet-based systems have greatly increased the speed and efficiency of trading, they still require a relatively complicated procedure of key stroke input. For example, CyberTrader™ requires that a user shall first enter the ticker symbol for a selected security, then enter the price, then the number of shares, and finally click on a confirmation button.

Currently available network-based trading platforms do not provide a dynamic display, in pictorial form, of current, relevant information concurrently with the trading interface so as to indicate what the market is doing with respect to a particular financial instrument at the time of financial-transaction execution. Precious minutes are often lost switching between programs and platforms to gather information and, with the information in hand, effect a network-based trade. The order placement process in many computer-based trading systems requires the user to interact with a form—which is a collection of graphical elements (e.g., text input area, label, button, etc.) through which the user issues commands, keys data into the computer system or both. Once an order is placed, the status of the order and its relation to the market is not always apparent. Similarly, desired changes to the resulting open order also take a forms-based approach, which often increases the time spent on the process as a result of the time necessary to refresh screens and download the revised data. The time taken to place a trade and to change an open order often requires that a trader shift attention to the mechanism of the user interface, rather than to maintain a focus on the market or the security in question, and hence obtain additional beneficial insight.

Therefore, a problem exists in the current heatmap art to present large amounts of current or real-time financial information in a form that allows users to quickly interpret, process, and make decisions based on the information and by which users can initiate and/or execute financial transactions over a network by indicating a location on the interface.

### 4. SUMMARY

In one embodiment, the invention is directed to network-based methods, systems, software, and architecture that provide interactive interfaces that pictorially represent large amounts of continually or periodically updated information. The term “interactive” means that the interface user can indicate a location on the pictorial representation to initiate or execute a transaction via a network, in connection with the particular information pictorially conveyed by the indicated location. Preferably, the information is financial information relevant to one or more financial instruments. In one aspect, this exemplary embodiment includes network-based interactive, pictorial interfaces providing images, where one or more pictorial parameters, such as, but not limited to, color, size, shape, dimension, depth, location, and/or pattern of the image correspond to a numerical value, a change in a numerical value, a numerical range, or a change in numerical range according to a defined numerical formula or relationship. The interactive, pictorial interfaces of the invention provide a platform by which interface users can initiate or execute financial transactions over a network by selecting a location on the interface, for example, by mouse click. In another aspect of the invention, the user can initiate or execute a financial transaction with respect to a financial instrument, by clicking a location on the interactive, pictorial interface via a computer-mouse to instruct transactional software to transmit an appropriate transaction instruction through a communication channel to a network-based trading platform.

In another-embodiment, this invention provides network-based systems, methods, architecture, and software in connection with an interactive, network-based interface in the form of a heatmap representing current financial data, wherein the interface allows initiation and/or execution of financial transactions by selecting a location on the interface's graphics (for example, selection by computer-mouse click). The systems, methods, architecture, and software of the invention can mediate financial transactions with respect to any financial-instrument, for example, transactions involving stocks, bonds, futures, options, derivatives, warrants, swaps, mortgages (interest rates), currency, or precious metals.

In still another embodiment, the invention provides network-based systems, methods, architecture, and software, whereby large amounts of periodically or continually updated financial information is dynamically represented in an interactive heatmap by cells according to cell size, cell location, and the color shading (color temperature) of the cell. In accordance with another aspect of this embodiment, each cell represents several parameters or variables with respect to underlying subject matter. For example, each cell of the interactive heat map can represent multiple parameters of an associated financial instrument, including, but not limited to, as price, the financial instrument's economic sector, and the size of the company issuing the instrument. As the heatmap interface is periodically updated with current financial information and/or receives streams of financial information in real-time, the size, location, and/or color or color intensity (temperature) of each individual cell automatically changes as appropriate to reflect changes in corresponding parameters or variables. Preferably, each cell's color and/or color intensity correlates with a color index representing a numerical range. The interactive heatmap interface of the invention provides a graphically intuitive, fast, user-friendly application for traders to receive and process financial information. In an exemplary embodiment, the display functions in real time such that a user will receive a dynamic representation of existing market conditions at that instant in time with respect to any selected financial instrument.

The invention further provides network-based systems, methods, architecture, and software in connection with trading financial instruments by selecting cells of the heatmap interface. A user of the interactive heatmap interface of the invention can initiate a transaction, execute a transaction or both with respect to a selected financial instrument by selecting its corresponding cell. For example, in one aspect of the invention, the user can initiate or execute a financial transaction with respect to a financial instrument, by clicking the cell with a computer-mouse cursor or moving a cursor or pointing device over that cell to instruct the transactional software to transmit an appropriate transaction instruction through a communication channel to a network-based trading platform.

### 5. BRIEF DESCRIPTION OF THE FIGURES

These and other features, aspects, and advantages of the present invention will become better understood with regard to the following description, examples, appended claims, and accompanying drawings where:

FIG. 1 is a block diagram outlining a general system for implementing the invention;

FIG. 2 is a block diagram outlining a financial data server useful in implementing the invention;

FIG. 3 is a block diagram outlining a pictorial interface station useful in implementing the invention;

FIG. 4 is hardware block diagram of a system according to one embodiment of the invention;

FIG. 5 is a block diagram of software modules useful for implementing the invention in accordance with another embodiment of this invention;

FIG. 6 is a computer screen shot of a web page comprising a pictorial interface of the invention in the form of a heatmap; and

FIG. 7 is a computer screen shot of a web page comprising a pictorial interface of the invention in the form of a heatmap.

### 6. DETAILED DESCRIPTION

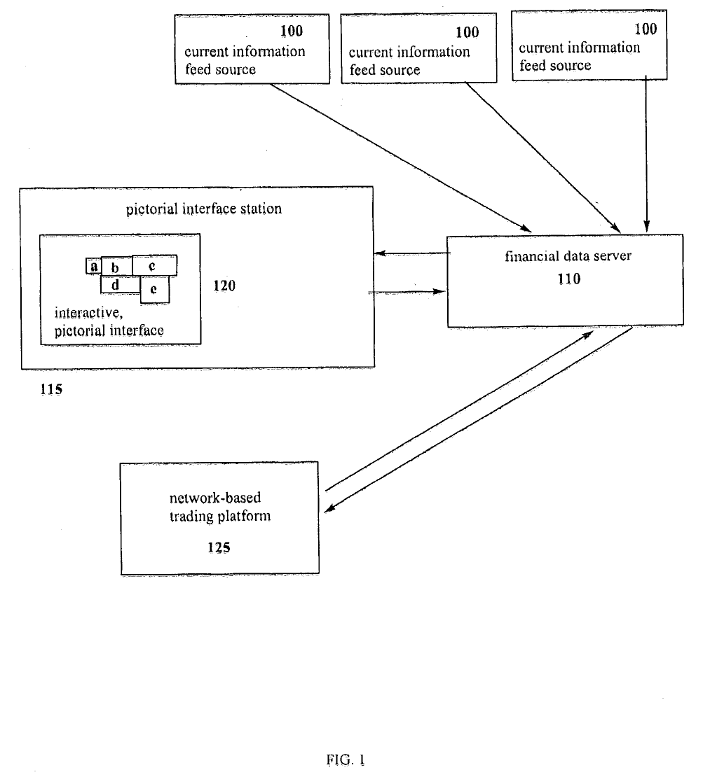

FIG. 1 is a diagram outlining a primary embodiment of the invention. Current information feed sources 100 provide current financial information to financial data server 110 by way of a network connections, as known in the art. Financial data server 110 converts the current financial information into a form processible by pictorial interface station 115. Pictorial interface station 115 renders one or more images on interactive, pictorial interface 120—preferably, a heatmap—based on the processible data supplied by financial data server 110. Preferably, pictorial interface station 115 is a computer work station or personal computer. A user views the one or more images on interactive pictorial interface 120 and can select an image location (e.g., 120a-e) based on one or more of the image's pictorial parameters including, but not limited to, color, size, shape, dimension, depth, location, and/or pattern of the image. Preferably, the image's pictorial parameters represent particular information (defined by a relationship or numerical formula) in connection with a particular financial instrument. Selection can be accomplished by well known methods in the art, such as by clicking the location with a computer mouse. Preferably, the selected location is a cell on a heatmap and the user selects the cell based on one or more of its size, location, and/or color temperature.

In an exemplary embodiment of the invention, by selecting the location, the interface user communicates financial-transaction instructions over a network to financial data server 110 in connection with one or more financial instruments corresponding to the selected location. Financial data server 110, in turn, communicates with network-based trading platform 125 to executes the transaction instructions. In another embodiment of the invention, by selecting the location, the interface user communicates financial-transaction instructions over a network directly to network-based trading platform 125 to executes the transaction instructions. In summary, by clicking on a color-coded cell of a heatmap, the user of pictorial interface station 115 can initiate a transaction to buy or sell financial instruments, such as such as stocks, bonds, futures, options, derivatives, warrants, swaps, mortgages (interest rates), currency, or precious metals.

### 6.1 Architecture

6.1.1 Current Information Feed Sources

As represented in FIG. 1, financial data server 110 accepts periodic and/or real-time information from information feed sources 100 through network connections. There are many sources of information feeds. Typically, such sources are accessible by way of network connections, preferably, electronically via the Internet and the World Wide Web. Current information respecting financial instruments, such as prices, variables and parameters that affect price, can be downloaded from feeds 100 to financial data server 110 in a continuous stream by methods well known in the art. The system administrator can readily access the necessary network addresses to periodically or continuously download current information, preferably, on a real-time basis.

In one embodiment, financial data server 110 accepts a continuous stream of market prices for publicly traded financial instruments, such as commodities and securities, for example, from Teknekron (TiBCO) (http://www.tibco.com), Reuters (www.reuters.com), and EDG Rate Publisher, which sources can provide real-time equity prices, real-time foreign-exchange (FX) rates, and real-time yield curves.

6.1.2 Financial Data Server

Financial data server 110 comprises a set of computers, such as work stations or web servers that, as shown in FIG. 1, receive data from current information feeds 100 and convert the information into a form processible by the pictorial interface station 115. Preferably, financial data server 110 communicates with station 115 in eXtensible Markup Language (XML). Financial data server 10 may also comprise a single computer, depending on the application. Also as shown in FIG. 1, financial data server 110 communicates with network-based trading platform 125 so as to initiate or execute financial transactions, with respect to a particular financial instruments, that are requested by a user through pictorial interface 120.

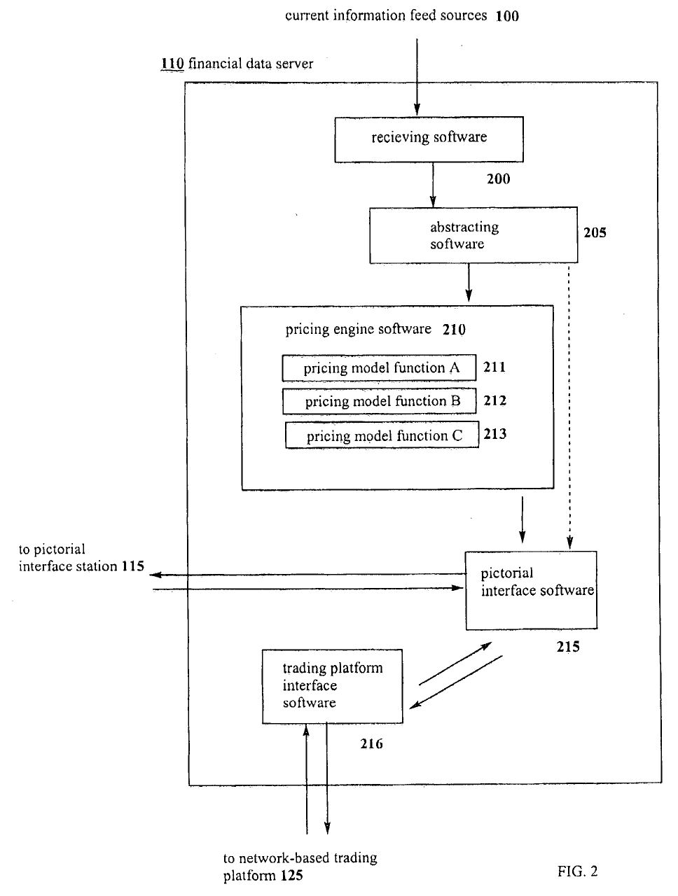

As shown in FIG. 2, current information receiving software 200 of financial data server 110 continuously or periodically receives current information from feeds 100 that are represented as images on pictorial interface 120. Preferably, the information is financial information or data relevant to one or more financial instruments.

In one embodiment, abstracting software 205 processes the current-information feed into a form processible by pricing-engine software 210. A pricing engine is necessary where financial instruments tradable through network-based trading platform 125 do not correspond to standard exchange-traded products and, therefore, require valuation before any financial transaction. Pricing engine software 210 employs pricing-model functions (e.g., 211, 212, and/or 213) for valuation of such financial instruments. Sophisticated pricing models to price complex and exotic financial instruments, such as derivatives are now well known in the art. For a detailed discussion and disclosure of pricing models see JOHN C. HULL, OPTIONS, FUTURES, AND OTHER DERIVATIVES (5th ed. 2002), hereby incorporated by reference herein. Preferably, the pricing models 211-213 and software 210 used in the invention allow for trader input and order flow information and valuate the financial instruments based on real-time pricing information obtained from networked market data services, such as Teknekron (TiBCO) (http://www.tibco.com); Reuters (www.reuters.com); and/or EDG Rate Publisher.

In another embodiment, as represented by the dotted arrow, where a pricing engine is not required because accurate financial instrument prices are directly available over a network, abstracting software 205 processes the current-information feed directly into a form processible by pictorial interface software 215 using Real Time Transfer Protocol (RTTP). Pictorial interface software 215 communicates with pictorial interface station 115 to provide information for rendering pictorial interface 120 and to receive financial-transaction instructions from the interface user. Pictorial interface software 215 also communicates with trading platform interface software 216. Software 215 and 216 translate programmatic requests from pictorial interface station 115 (which are in the native format of the operating system and application platform of pictorial interface station 115) into a suitable protocol, such as Simple Object Access Protocol (SOAP) messages or HTTP for communication with network-based trading platform 125. The specifications of the format of the SOAP messages form the Market Trading Protocol (MTP). Preferably, financial data server 110 comprises a local area network (LAN) as is known in the art.

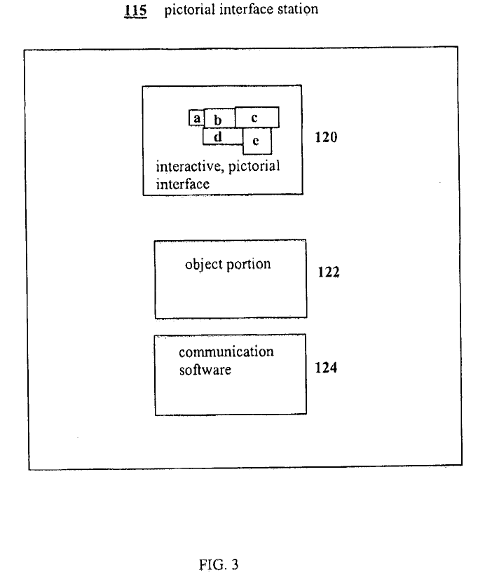

The communication software 124 (FIG. 3) of pictorial interface station 115 is designed to accommodate the “plug-and-play” addition and removal of communication components, each component implementing a specific type of communication protocol (e.g. HTTP and SOAP) for interfacing with the network-based trading platform 125 or interface software 215. Data, confirmations, and other communications originating from network-based trading platform 125 are also received by trading platform interface software 216 and converted to a form processible (e.g., MTP format) by pictorial interface software 215 for transmission to pictorial interface station 115.

Software for performing each of the above functions is commercially available or readily designed by one of skill in the art.

6.1.3 Heatmap Interface

In this exemplary embodiment, interactive, pictorial interface 120 is a heatmap interface. In its most basic form, a heatmap interface for use in the invention comprises a plurality of cells or boxes, each cell representing a variable or parameter in connection with financial information. Each cell is color coded to represent a numerical value for the financial variable or parameter, which correlates with a color index. Preferably, a color index bar, providing a color-range continuum representing a numerical range according to a chosen formula, is presented at the bottom of the heatmap. Preferably, the cells themselves are organized on the heatmap in a logical grouping. The size of the cells may also represent a parameter or variable. For example, the cells can be organized according to industry sectors.

Preferably, one or more of the cells has a corresponding pop-up sub-menu that appears when the user selects a particular color-coded cell. The sub-menu provides the user with additional information or allows the user to select from among several options, for example, the option to initiate or execute a financial transaction.

Preferably, the heatmap interface automatically updates at periodic intervals, for example, every five or ten minutes to reflect changes in the represented variables or parameters, more preferably, the heatmap interface updates continuously in real time. Preferably, the heatmap software allows the user to customize the view, for example, variables and parameters in connection with the financial instruments, cell organization, cell size and color index.

Typically, heatmaps are rendered by first instructing a map server to retrieve the input data from a storage location, such as one or more databases. The data is condensed and sent to the requesting client via a network along with meta data to the map client. The client software then interprets the meta data, unpacks the compressed data feed, and renders a heatmap on the client screen via a map-rendering algorithm. Map rendering algorithms are well known in the art and commercially available for example, from Panoptican Software, Stockholm, Sweden, having an Internet address at http://www.panopticon.com. The software that renders the heatmap contains software for displaying menus.

Turning to FIG. 3, pictorial interface station 115 is illustrated herein as having a three-component architecture, consisting of the pictorial interface 120, an object portion 122 and communication software 124. The pictorial interface 120 and associated software contains components that handle the graphics operations. These include rendering images on the pictorial interface, dynamic operations such as moving and highlighting locations on the images and interactive operations like responding to user actions.

The object portion 122 groups together components that perform business logic and components that implement utility functions. The components in this layer: (1) validate users' actions (performed on objects belonging to the pictorial interface 120), (2) translate users' actions into commands to be sent to financial data server 115 via communication software 124 and (3) process return values, notification messages, or any other data transmitted by financial data server 125 (through the communication software 124). The communication software 124 consists of components that act as communication gateways between the pictorial interface station 115 and financial data server 115. Such software is well known in the art and/or readily designed by one skilled in the art.

6.1.4 Network-Based Trading Platform

Financial data server 110 can communicate with a wide variety of network-based trading platforms 125. This includes any network-based trading platform that can: (1) manage online trading accounts, (2) publish quotes (3) receive orders, (4) execute orders, and/or (5) provide feedback to the trader on the status of his/her orders. Any platform permitting network-mediated financial transactions is a suitable network-based trading platform 125 for use in the invention, for example, financial institutions, approved electronic communication network trading systems (ECN), stock exchanges, financial instrument exchanges, futures exchanges, a bourse, or an auction server.

In one embodiment, the network-based trading platform 125 acts as an information source 100 to provide pricing information regarding one or more commodities, preferably, listed commodities, such as stocks, bonds, futures, options, warrants, swaps, real estate, mortgages (interest rates), currency, or precious metals to financial data server 110. Architecture and software permitting communication between market data server 110 and network-based platform 125 are well known in the art. For example, such architecture and software is disclosed in U.S. Patent Publication 2003/0004853 A1 (published Jan. 2, 2003) to P. Ram et al., hereby incorporated herein by reference.

Examples of network-based trading platforms suitable for practice of the invention include, but are not limited to, Orc Software (http://www.orcsoftware.com); Imagine.com Communications (http://www.imagine.com); and AQTOR software by Actant, Inc (http://www.actant.com).

### 6.2 Embodiment: the Click-to-Trade Heatmap

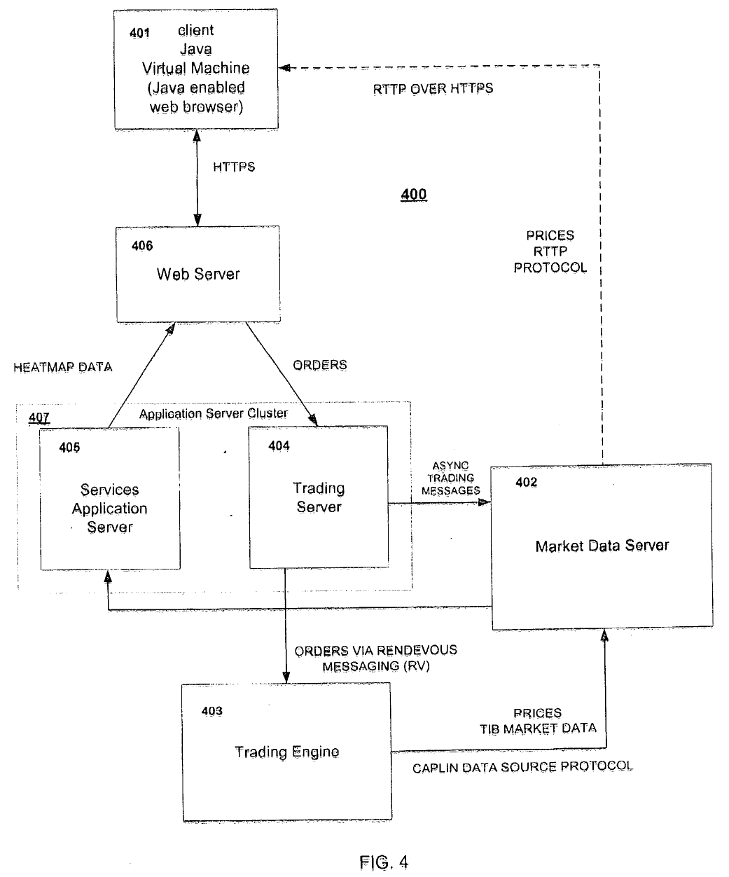

A specific embodiment 400 of the invention is the “Click-to-Trade Heatmap”. FIG. 4 shows a hardware system block diagram according to one aspect of this invention. The user interface is provided through client 401 running the live heatmap interface within a Java virtual machine environment. The client can be a desktop PC with a Java enabled browser such as the Microsoft's Internet Explorer, or it can be any other suitable computer, personal computer, or workstation as known in the art.

Market data server 402 collects real time raw and processed streaming financial data and financial instrument pricing from trading engine 403. This includes TIB financial data (streaming data provided by commercially available products from TIBCO Software Inc., www.tibco.com), or data sent via streaming data such as commercially available products from Caplin Systems Ltd. (www.caplin.com) Real Time in Text Protocol (RTTP) to market data server 402. Market data server 402 also receives asynchronous trading messages from the trading server 404. Market data server 402 can be a UNIX RTTP server running Caplin Liberator.

In this specific embodiment, trading engine 403 can be a UNIX server running Java secure networking, but it can also be another type of server running suitable software. Trading engine 403 matches and processes orders and publishes the prices of financial instruments that can be traded by the system. There is typically a pricing engine “behind” or within trading engine 403. The pricing engine typically performs basic calculations of theoretical worth of a particular financial instrument. Trading engine 403 can then make adjustments to the theoretical prices for a variety of reasons. Trading engine 403 can also adjust prices based on activity related to a particular instrument. Client 401 can receive streaming data from market data server 402, but more likely gets periodic updates of the data displayed on the heatmap from the services application server 405 via web server 406.

Services application server 405 is typically a UNIX server running Weblogic (BEA Systems, Inc.) under Java, but it can also be another type of server running suitable software. Services application server 405 can receive financial data related to financial instruments and form that data into one or more XML files. The XML files are then mapped to Java objects and linked via libraries to the heatmap running on client 401. It is also possible to provide streaming financial data to client 401 via an optional feed from market data server 402. This data can be fed to the client via the Caplin RTTP protocol over HTTPS, a secure hypertext transfer protocol (HTTP).

Web server 406 can be a UNIX server with Apache (www.apache.org), but it can also be another type of server running suitable software. When a user clicks on the heatmap to buy or sell a security, the order is processed by trading server 404 via web server 406. Trading server 404 also can be a UNIX server running Weblogic (BEA Systems, Inc.,www.beasys.com) under Java, but it can also be another type of server running suitable software. It can also run on the same machine as services application server 405. Trading server 404 can communicate with trading engine 403 via the rendezvous messaging library (RV, as offered by TIBCO Software Inc.). Other messaging systems such as MQSeries (www.ibm.com), Java message service (JMS), or TCP-IP, IPX or other networking or non-networking protocols can be used.

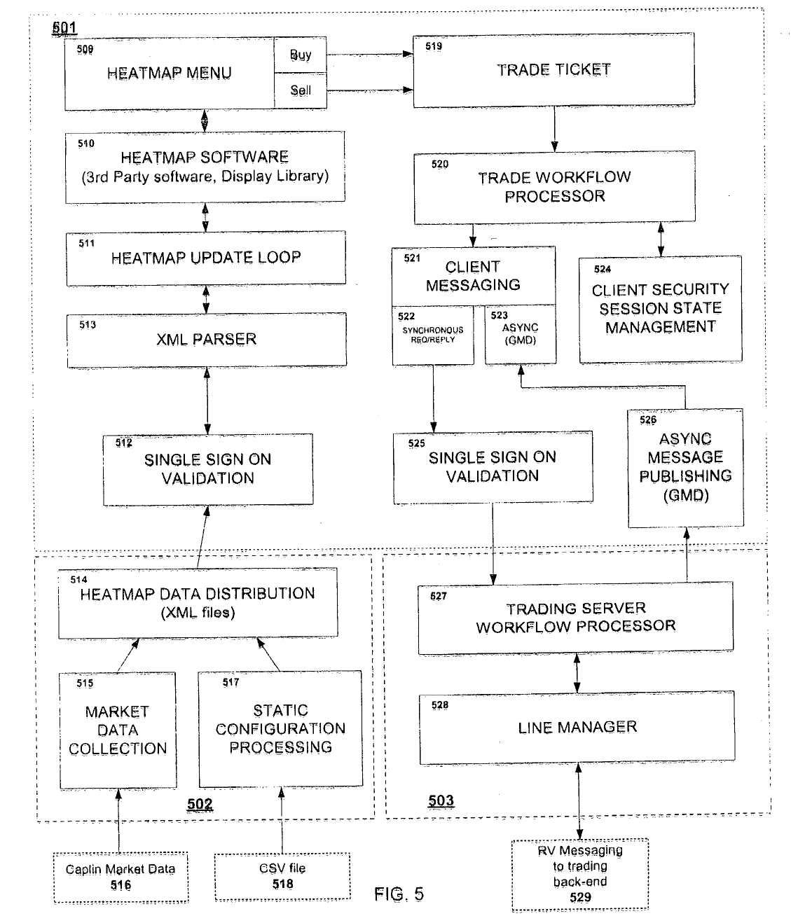

The various software blocks useful to accomplish the inventive Click-to-Trade Heatmap system 500 using real-time data are shown in FIG. 5. The figure is broken down into three sections: the client applet 501, the services center 502, and the trading server 503. According to this exemplary embodiment, software shown within the dotted region 501 typically resides on the hardware acting as client 401. Software shown in the dotted region 502, typically resides an application server cluster corresponding to the dotted region 407 on FIG. 5. Client applet 501 can be a Java applet or accomplished in other computer languages as known in the art. Services application server 405 and the trading server 404 can also reside on one computer as opposed to being arranged as a cluster of multiple servers. The dotted region 503 generally corresponds to the market data server 402 of FIG. 4.

The heatmap can be produced by commercial software 510 such as that offered by Panopticon Software AB. The heatmap variables are updated periodically when update requests are made by the heatmap update loop 511. The updated data is mapped from the XML heatmap distribution file 514 received from services server 502 via sign on validation 512 by XML parser 513. The XML heatmap file 514 can be a snapshot of data representing aggregated market data for thousands of financial instruments. The XML files comprise market data collected by software block market data collection 515 which can be feed from streaming financial data sources such as Caplin's streaming market data 516. Also, static heatmap configuration data, including such things as entries and functions of heatmap pull-down menus, can be read from a comma separated variable (CSV) datafile 518.

On the trading side, when the user of client 501 desires to execute a trade for a financial instrument, such as a bond, they can select the appropriate customized pull down menu 509. A selection of buy or sell can cause trade ticket 519 to show on the screen of client 501, as by a “pop-up” screen. Data entry fields on trade ticket 519 can include quantities to buy or sell and can display the corresponding prices. Such prices can be ultimately derived from trading server workflow processor 527 via asynchronous messaging 526/523 and client messaging block 521 as controlled by trade workflow processor 520. Asynchronous messaging 526/523 can follow the GMD standard for asynchronous messaging or other asynchronous standards as known in the art. Session security and sign on validity is accomplished via blocks 524 and 525. Line manager 528 coordinates buy and sell actions from trading server 527 from trading server 503 to the “back-end” trading system 529 to complete the financial transactions.

### 6.3 EXAMPLE

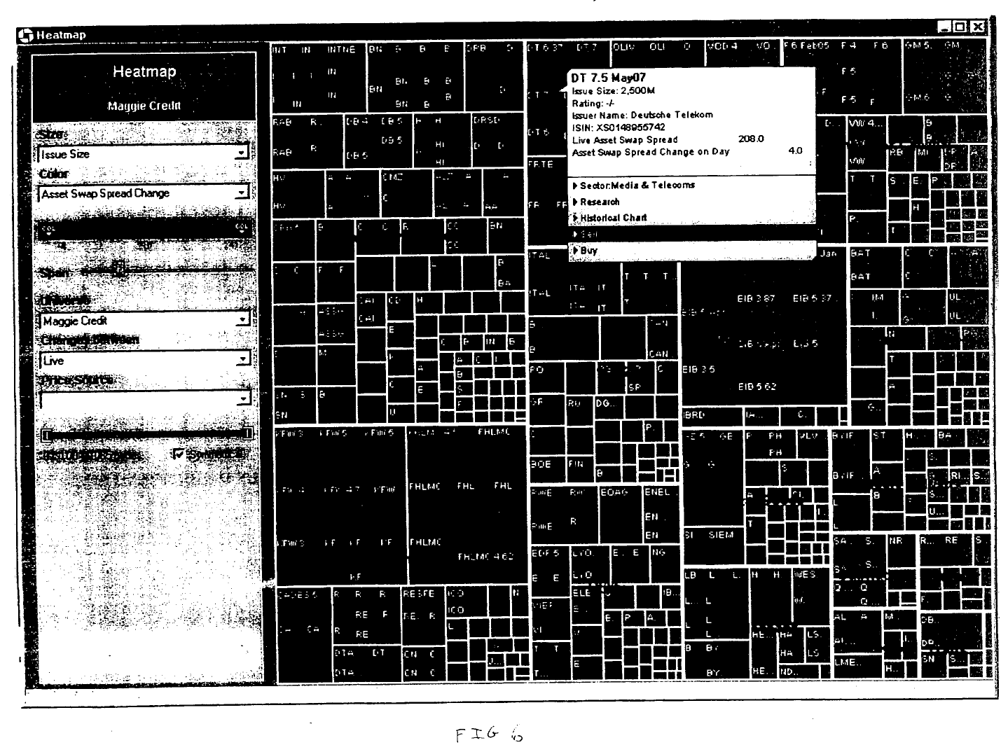

FIG.'s 6-7 show screen shots exemplifying use of the network-based methods and systems of the invention. FIG. 6 is a screen shot of a heatmap interface of the invention (heatmap interface 120 of FIG. 1) representing various credit bonds. In this case, the screen shot comprises the “Maggie Credit” universe, which is divided into sectors represented by the white bars (i.e., the sectors of “Financial Institutions”, “Utilities”, “Consumer Cyclicals”, “Consumer Non-Cyclicals”, etc.). Each cell represents a particular credit bond. In this example, the size of the cells is set to reflect issue size.

The organization of the cells, sectors, and/or universes can be any logical organization and is readily defined by the system administrator based on various considerations, for example, the financial instruments transacted, industry standards, etc. In this particular example, the Maggie Credit universe is an index designed in view of the fact that the heatmap offers swap transactions in credit bonds.

The color index bar shown on the left reflects the temperature of the real-time asset swap spread change (ASSC) on a scale of −4 to +4. ASSC is an analytic showing the difference between the current asset swap spread and the asset swap spread at the close of the previous day. The index bar's blue end represents smaller spread differences and the red end indicates larger spreads. A user viewing the cells' color temperature immediately can identify particular credit bonds of interest according to his investment strategy. The color index can be any of a variety of different color schemes depending on preference.

Further illustrated in FIG. 6, by scrolling the mouse cursor over the red shaded box DT 7 . . . , a pop-up menu appears providing information and options in connection with the DT 7.5 credit bond. Information provided in the upper portion of the pop-up menu includes: (1) the issue size of the DT 7.5 credit bond; (2) its rating (not available); (3) the corporation issuing the DT 7.5 credit bond (i.e., Deutsche Telekom); (4) its International Securities Identification Number (ISIN No.), which is a unique identifier for credit bonds according to international standards; (5) the live asset swap spread, which is the current swap spread, and which can be streamed in real time or updated periodically; (6) the numerical value of the Asset Swap Spread Range according to the color index; and (7) the particular sector which the DT 7.5 credit bond is located (in this example, the Media & Telecom sector).

The pop-up menu of FIG. 6 further provides the user with several options in connection with the DT 7.5 credit bond. For example, the research option could bring the user to a research site (not shown) providing financial information for the DT 7.5 credit bond; its sector; or any other financial information according to the system's setup. The historical chart option could bring the user to another application which providing an historical graph (not shown) of the DT 7.5 credit bond. In this example, the pop-up menu also provides the user the option to enter into a buy or sell transaction with respect to the DT 7.5 credit bond.

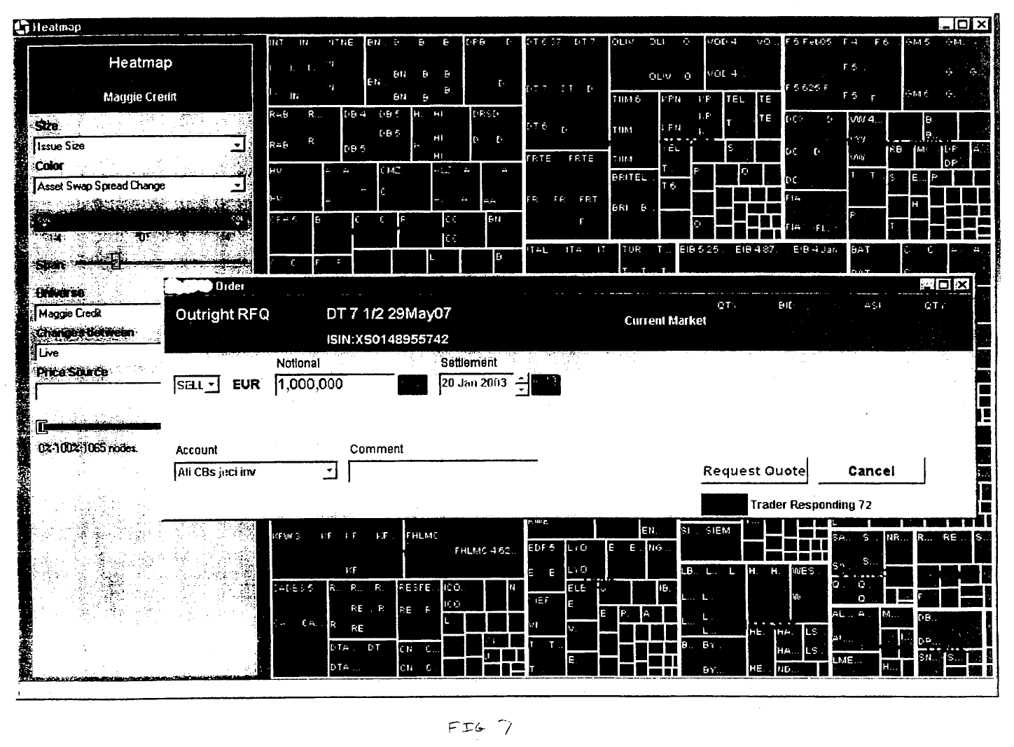

In this case, the user has selected the option to sell the bond and a new pop-up menu (order ticket) appears (FIG. 7) allowing the user to enter a notional amount that the user wishes to transact and a settlement date. The user has entered the notional amount of 1,000,000 and a settlement date of Jan. 20, 2003. Upon the user selecting the “Request Quote” button, the trader on the other side of the transaction will receive the order ticket (not shown) and can then respond with a quote, for that specific ticket, based on the user's suggested notional amount and settlement date. The system could, of course, also be configured to process an immediate ticket, wherein the user would initially receive a firm price so that when the order ticket is raised, the trade can be immediately, automatically executed through the network-based trading platform without any back-and-forth communication.

### 6.4 Definitions

As used herein, the phrase “pictorial interface” means an interface displaying one or more pictorial images wherein one or more pictorial parameters of the image including, but not limited to, color, size, shape, dimension, depth, location, and/or pattern correspond to data or information according to a defined relationship. Preferably, one or more of the pictorial parameters corresponds to a numerical value, a change in a numerical value, a numerical range, or a change in numerical range according to a defined numerical formula or relationship.

As used herein, the term “heatmap” means a pictorial interface comprising a plurality of colored cells, wherein one or more of the cells represents a particular parameter or variable (the “underlying parameter or variable”), and wherein the color shade of each cell (also referred to as cell temperature) imparts data or information respecting the parameter or variable represented by that cell to a viewer of the heatmap. Preferably, one or more of the cells represents data or information in connection with a financial instrument, for example, but not limited to, stocks, bonds, futures, options, derivatives, warrants, or swaps. Preferably, the value of the underlying parameter or variable corresponds directly to the particular color shade of its corresponding cell. It is also preferable that the underlying parameter or variable is a numerical value. Preferably, the heatmap is accompanied by a color index, which indicates how the color shades translate into the underlying data or information. Thus, the index bar can represent the numerical color range of the heatmap according to a chosen formula. For example, a particular shade of blue might represent, according to a particular color index, that a stock price increased by $20.50/share from the previous day's close. It is also preferable that the size and location of the heatmap cells imparts information or data to the viewer. In a popular format, color provides a measure of numerical values, and cell location provides qualitative information, such as the sector of the business economy. It is further preferable that the heatmap is periodically updated or continually updated by real-time data feeds so that it represents updated or current information. As the heatmap receives periodic information or information from real-time data feeds, the color and intensity of the picture changes, indicating a shift in numerical value or a change in one or more other variables or parameters of the data or information represented.

As used herein, the term “network” means any system of two or more interconnected computers. Examples of networks include, but are not limited to, the Internet and other Wide Area Networks (WANs), and Local Area Networks (LANs).

A network for use in the invention is the Internet. When capitalized, the term “Internet” refers to the collection of computers, computer networks, and gateways that use TCP/IP protocols. Internet resources for transferring information include File Transfer Protocol (FTP) and Gopher. Preferably, however, information is transmitted and received over the Internet by way of the World Wide Web. The World Wide Web is the collection of servers and computers that use Hypertext Transfer Protocol (HTTP) for transferring data files. Users interact with the World Wide Web through web pages, which are logical blocks of information formatted with Hypertext Markup Language (HTML) or Extensible Markup Language (XML). Web pages are identified by a Uniform Resource Locator (“URL”), which is a special syntax identifier (network address) defining a communications path to the web page.

A browser is a program capable of submitting a request for a web page identified by a URL. Retrieval of web pages is generally accomplished with an HTML- or XML-compatible browser that browses web sites. A web site is a group of related HTML documents and associated files, scripts, and databases that is served up by an HTTP server on the World Wide Web.

As used herein, the phrase “network connection” means any channel by which a person, party, or business entity can interface or communicate with a network. Examples of network connections include, but are not limited to, telephone lines by way of internal or external modems, digital subscriber lines (“DSL”), connections to voice mail and voice pages; dedicated data lines; cellular phone communication; communication by way of satellite; and cable television lines.

As used herein, the term “platform” means a system of software and hardware located on a network that performs a function, such as providing services or information, and which is accessible through a network interface from a requesting computer. A typical platform for use in the invention comprises a data base of various data tables and server engine, which receives HTTP requests to access the platform's web pages identified by Uniform Resource Locator (“URL”) and provides the web pages as an interface to a requesting computer.

As used herein, the term “interface” means a displayed or transmitted, user friendly set of pictures, text, voice statements, or other communication means that provide instructions and protocols indicating how a user is to communicate and interact with a platform. For example, an interface allows a user to direct computer software located on the user's computer or within a network. Examples of interfaces include, but are not limited to, Web pages, e-mail transmittals, voice pages, voice mail instructions, and facsimile transmissions (fax). An interface is displayed or provided by an “interface provider”, for example, a personal computer displaying a Web page interface.

As used herein, the phrase “network-based trading platform” means a platform, accessible by way of a network that provides investors with access to pricing information in connection with commodities. Preferably, a network-based trading platform further provides automated, network-based trading services. A preferred network-based trading platform allows a trader to enter an order to buy or sell a financial instrument, which order is transmitted to an introducing broker or to the central system of the applicable exchange. A preferred network based trading platform for use in the invention is the company Orc Software (http://www.orcsoftware.com) that provides architecture for trading commodities in real time.

As used herein, the term “automatically” means execution by computer software upon occurrence of an event or satisfaction of a condition without instruction from or intervention of a user.

As used herein, the phrase “financial transaction” means any transaction involving the transfer or future transfer of anything of value, such as goods, services, or currency or any transaction involving a contract.

As used herein, the term “financial instrument” means any instrument indicating or representing rights in or ownership of something of value. Example of financial instruments include, but are not limited to, stocks, bonds, futures, options, derivatives, warrants, swaps, contracts, loans, liens, mortgages, interest rates, currency, precious metals and any writing, record, document, or certificate indicating ownership therein.

As used herein, the phrase “listed financial instrument” means any financial instrument that is listed on an exchange for public or private trade. Examples of exchanges include, but are not limited to, the American Stock Exchange, Chicago Board of Exchange, Chicago Board of Trade, International Securities Exchange (options), NASDAQ Stock Market, and the New York Board of Trade.

As used herein, the phrase “exchange rate” means the price listed by an exchange for a listed financial instrument at a particular time.

### 6.5 Conclusion

In view of the above Background, Summary, Figures, Detailed Description, and Example presented above, it is clear that in certain embodiments, the invention comprises a method for initiating or executing a transaction over a network comprising:

(a) generating an interactive interface, using computer software, comprising a pictorial image, the pictorial image pictorially representing data or information according to a pre-defined formula;

(b) selecting a location on the pictorial image;

(c) initiating or executing the transaction over the network in connection with the data or information pictorially represented by the selected location.

Although the present invention has been described in considerable detail with reference to certain preferred embodiments and versions, other versions and embodiments are readily implemented by those of skill in the art. Therefore, the scope of the appended claims should not be limited to the description of the versions and embodiments expressly disclosed herein.

What is claimed is:

1. A method of initiating or executing a transaction over a network comprising:
(a) generating an interactive interface, using computer software, comprising a pictorial image, the pictorial image pictorially representing data or information according to a pre-defined formula;
(b) selecting a location on the pictorial image;
(c) initiating or executing the transaction over the network in connection with the data or information pictorially represented by the selected location.

2. The method of claim 1, wherein the transaction is a financial transaction.

3. The method of claim 1, wherein the financial transaction comprises a financial instrument and the selected location represents data or information related to the financial instrument.

4. The method of claim 1, wherein the financial transaction comprises the purchase or sale of the financial instrument.

5. The method of claim 1, wherein the interactive, pictorial interface comprises a heatmap.

6. The method of claim 1, wherein the selected location corresponds to a cell on the heatmap.

7. A method for providing a graphical user interface for use in analyzing data and executing transactions related to the data comprising:
providing data to said graphical user interface;
generating a graphical representation of said data on a predefined area of said graphical user interface, wherein said graphical representation changes as said data changes;
providing a user input configured to select any area of said graphical user interface to initiate a transaction relative to the data associated with said area.

8. A method in accordance with claim 7 wherein providing data comprises receiving data from a source via a data transmission medium.

9. A method in accordance with claim 8 wherein said data transmission medium comprises the Internet.

10. A method in accordance with claim 7 wherein providing data comprises receiving data from a plurality of sources via one or more data transmission media.

11. A method in accordance with claim 7 wherein generating a graphical representation of said data comprises processing said data according to an algorithm to generate graphical representations of parameters associated with said data.

12. A method in accordance with claim 11 wherein one of said parameters of said data is associated with color.

13. A method in accordance with claim 7 wherein said data is associated with financial markets and initiating a transaction comprises executing a transaction in one or more of said financial markets.

14. A method in accordance with claim 13 wherein said transaction is executed directly in response to said input device being manipulated over said predefined area of said graphical user interface.

15. A system for initiating or executing financial transactions comprising:
a financial data server having a graphical user interface and a user input device;
a data source connected to said processor configured to deliver data to said financial data server; and
a network-based trading platform connected to said financial data server configured to initiate or execute transactions in a financial market related to said data source;
said graphical user interface having a predefined area associated with said data, wherein parameters of said data are represented graphically;
said user input device configured to select an area on said graphical user interface and to initiate or execute a transaction via said network-based trading platform responsive to said selection.

16. A system in accordance with claim 15 wherein said graphical user interface comprises a heatmap.

17. A system in accordance with claim 15 wherein said user input device comprises a pointing device with user-manipulated buttons, wherein a transaction is initiated or executed when said pointing device points to an area on said graphical user interface and a user-defined button is pressed.

18. A system in accordance with claim 15 wherein information related to the data is further displayed responsive to said input device being moved over the data's predefined area on said graphical user interface.

19. A system in accordance with claim 15 wherein said data source comprises a plurality of data sources.
